(19) United States
(12) Patent Application Publication
(10) Pub. No.: US 2016/0274937 A1
(43) Pub. Date: Sep. 22, 2016

(54) CONTROL DEVICE

(71) Applicant: TOYOTA JIDOSHA KABUSHIKI KAISHA, Toyota-shi, Aichi (JP)

(72) Inventors: Kota SATA, Susono-shi, Shizuoka-ken (JP); Satoru WATANABE, Susono-shi, Shizuoka-ken (JP); Junichi KAKO, Susono-shi, Shizuoka-ken (JP)

(73) Assignee: TOYOTA JIDOSHA KABUSHIKI KAISHA, Toyota-shi, Aichi-ken (JP)

(21) Appl. No.: 15/030,242

(22) PCT Filed: Oct. 21, 2014
(86) PCT No.: PCT/JP2014/078426

§ 371 Date: Apr. 18, 2016

(30) Foreign Application Priority Data
Oct. 25, 2013 (JP) 2013-222239
Oct. 1, 2014 (JP) 2014-202801

(51) Int. Cl. G06F 9/48; F02D 41/00; F02D 41/26; G05B 15/02

(52) U.S. Cl. CPC G06F 9/4881; G05B 15/02; F02D 41/008; F02D 41/26

(57) ABSTRACT

As shown in FIG. 2, a common element is allocated to core 1, element #1 to element #n are allocated to core 2 to core n+1, and an overall correction element is allocated to core n+2. Element #1 to element #n are unique elements that are respectively independent. The common element and the overall correction element are elements that are dependent to element #1 to element #n. By separating a plurality of elements in accordance with properties of the operations and allocating the elements to different cores in this manner, it is possible to satisfy not only demands with respect to individual actuators, but also to satisfy comprehensive demands with respect to all the actuators.

### TECHNICAL FIELD

The present invention relates to a control device, and more particularly to a device for controlling a control object including a plurality of actuators.

### BACKGROUND ART

The conventional technology includes, for example, as disclosed in Patent Literature 1, technology in which six electronic control devices are provided in correspondence with the respective cylinders of a six-cylinder engine. According to the aforementioned control device, the operations of actuators that are provided for each cylinder, such as a fuel injection valve, an exhaust valve, a starter valve, and a cylinder lubrication device, can be controlled in cylinder units. That is, demands with respect to the respective actuators can always be satisfied. Further, even if a control device allocated to an actuator of a certain cylinder crashes, operation of the engine can be continued by means of the other normal control devices.

### CITATION LIST

### Patent Literature

Patent Literature 1: Japanese Patent Laid-Open No. 4-318253

### SUMMARY OF INVENTION

### Technical Problem

In a case where actuators exists for respective cylinders, it is desirable to satisfy not only demands with respect to individual actuators, but also to satisfy a comprehensive demand with respect to all of the actuators. This is because the balance of the actuators overall can be adjusted by satisfying a comprehensive demand. When seen from this perspective, the above-described control devices are inadequate. This is because the above-described control devices do not have a configuration that carries out the exchange of information between the control devices. Further, if one or more of the control devices crash, a malfunction that arises accompanying the crash cannot be compensated for by other normal control devices.

The present invention has been made in consideration of the above-described circumstances. That is, an object of the present invention is, in a control device for controlling a control object including a plurality of actuators, to satisfy both a demand with respect to individual actuators and also a comprehensive demand with respect to all of the actuators.

### Solution to Problem

To achieve the above-described object, a first invention is a control device for controlling a control object including a plurality of actuators, wherein:

the control device includes a multi-core type processor that processes a plurality of operation tasks that are necessary to control operations of the actuators;

the operation tasks include individual tasks that are specific to the respective actuators, and overall tasks that are common to all the actuators;

the processor is configured so as to process the individual tasks and the overall tasks by means of different cores;

the individual tasks are constructed so as to output an operation result in accordance with a demand command with respect to the respective actuators; and

the overall tasks include an operation result correction task that is constructed so as to correct the operation result in accordance with a comprehensive demand command with respect to the actuators.

A second invention is in accordance with the first invention, wherein:

the individual tasks are constructed so as to output an operation result in accordance with a demand command with respect to the respective actuators; and

the overall tasks include a common information creation task that is constructed so as to output information common to the actuators that is information necessary for processing of the individual tasks.

A third invention is in accordance with the first or second invention, wherein:

the control object is an internal combustion engine; and

the actuators are provided for each of a plurality of cylinders that the internal combustion engine includes.

### Advantageous Effects of Invention

According to the present invention, individual tasks that are specific to each of a plurality of actuators, and overall tasks that are common to all of the actuators can be processed by means of different cores. It is therefore possible to not only satisfy demands with respect to individual actuators but also to satisfy a comprehensive demand with respect to all of the actuators. Further, even in a case where one or more cores that process individual tasks crash, the overall balance of the actuators can be adjusted by cores that process the overall tasks.

### BRIEF DESCRIPTION OF DRAWINGS

FIG. 1 is a view illustrating an outline of a configuration of a control device according to an embodiment.

FIG. 2 is a view for describing the allocation of operational elements to cores 102.

FIG. 3 is a diagram illustrating a temporal relation between operations performed by respective cores.

FIG. 4 is a diagram illustrating a temporal relation between operations performed by respective cores.

FIG. 5 is a diagram illustrating a temporal relation between operations performed by respective cores.

FIG. 6 is a diagram illustrating a temporal relation between operations performed by respective cores.

FIG. 7 is a diagram illustrating a temporal relation between operations performed by respective cores.

### DESCRIPTION OF EMBODIMENT

A control device according to an embodiment of the present invention will be described hereunder using the accompanying drawings.

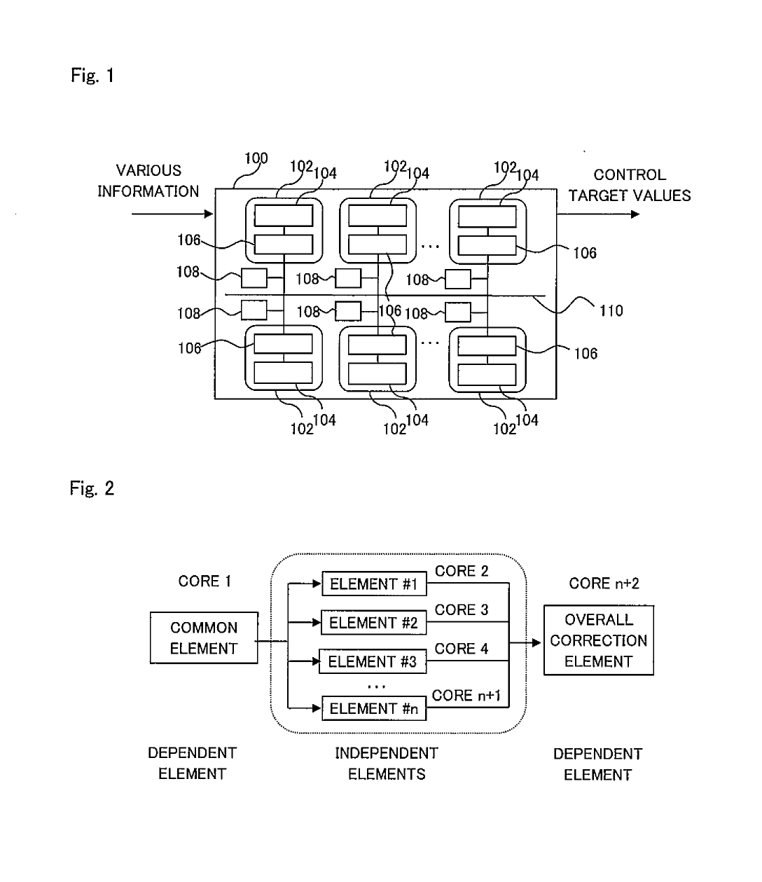

A control device of the present embodiment is equipped with a function that, with respect to control of a control object that includes a plurality of actuators, performs parallel operations with respect to control target values of the actuators using a multi-core type processor. FIG. 1 is a view illustrating an outline of the configuration of the control device of the present embodiment. Various kinds of information such as information relating to the status of the control object and information relating to the environment around the control object are input to the control device 100. Control target values that are calculated based on the various kinds of information are output from the control device 100.

As shown in FIG. 1, the control device 100 includes a plurality of cores 102. Each core 102 includes a CPU 104 and a cache 106. Various programs that are executed using the CPU 104 as well as various kinds of data used when executing the programs are stored in a local memory 108. The cores 102 are connected to each other by a bus 110. Communication between the cores 102 is performed through the bus 110. Although not shown in the drawings, a cache that is shared between the cores is also connected to the bus 110.

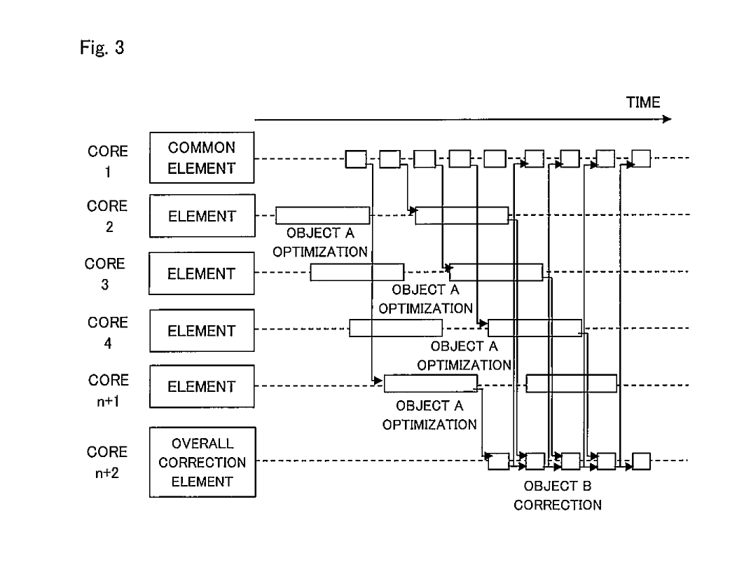

Calculation of control target values is performed by allocating a plurality of operational elements (operation tasks) to the plurality of cores 102. FIG. 2 is a view for describing allocation of operational elements to the cores 102. As shown in FIG. 2, a common element (common information creation task) is allocated to core 1, element #1 to element #n (individual tasks) are allocated to core 2 to core n+1, and an overall correction element (operation result correction task) is allocated to core n+2. Here, element #1 to element #n are unique elements that are respectively independent. On the other hand, the common element and the overall correction element are elements that are dependent to element #1 to element #n. The difference between the common element and the overall correction element lies in the relationship with the independent elements (that is, element #1 to element #n). That is, the common element is an element that is necessary for operations of the independent elements, while the overall correction element is an element that is calculated in light of operation results of the independent elements.

FIG. 3 is a diagram illustrating a temporal relation between operations performed by respective cores. As shown in FIG. 3, when a common element is calculated by an operation at core 1, the operation result is output to core 2 to core n+1. At core 2 to core n+1, element #1 to element #n (for example, optimization of object A) are calculated by operations using the operation result of core 1, and the results of the operations are output to core n+2. At core n+2, an overall correction element (for example, correction of object B) is calculated by an operation, and the operation results of core 2 to core n+1 are corrected using the overall correction element. The corrected results for element #1 to element #n that are obtained at core n+2 are reflected in an operation to calculate the overall correction element at the same core. Further, the corrected results for element #1 to element #n are output to core 1, and are reflected in an operation to calculate the common element at the same core.

As described with respect to FIG. 2 and FIG. 3, by separating a plurality of elements in accordance with a property (independent or dependent) of the operations and allocating the elements to different cores, it is possible to satisfy not only demands with respect to individual actuators, but also to satisfy a comprehensive demand with respect to all of the actuators.

Further, by separating a plurality of operational elements and allocating the operational elements to the different cores 1 to n+2, the operational load per core can be reduced. In addition, since the above-described n+2 cores are inside the same processor, the communication time can be shortened in comparison to a case where information is exchanged between a plurality of single-core processors. Accordingly, the time required for an operation with respect to a control target value can be shortened in the control device overall.

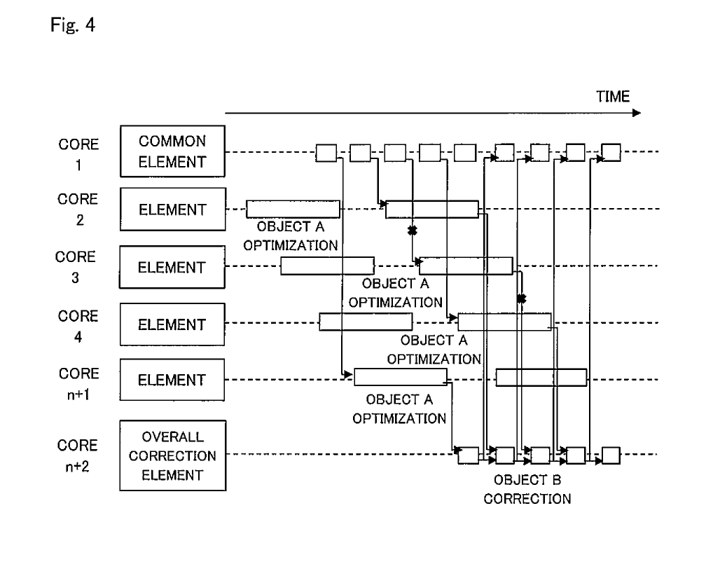

Furthermore, by separating independent elements and allocating the independent elements to the different cores 2 to n+1, even in a case where one or more of the cores 2 to n+1 crashes, it is possible to adjust the overall balance of the actuators by means of operations by core 1 and core n+2. This effect will now be described referring to FIG. 4. FIG. 4 is a diagram illustrating a temporal relation between operations performed+by respective cores in a case where core 3 has crashed. As shown in FIG. 4, in a case where core 3 crashed, the operation result of the common element is not input to core 3, and furthermore, because an operation with respect to element #2 is not performed at core 3, an operation result with respect to element #2 is not output to core n+2 from core 3.

The control device 100 is designed so that, in a case where any of the cores has crashed, an error signal is emitted from the crashed core, or an arbitrary bit indicates “0” or “1”. Therefore, core n+2 that received an error signal or the like from core 3 determines that core 3 has crashed, and interpolates a corrected result for the operation result for element #2 using an operation result for the overall correction element (that is, a corrected result for element #1 and element #3 to element #n) at core n+2 immediately before core 3 crashed. Thus, even in a case where an operation result for element #2 is not outputted to core n+2, the overall correction element is calculated by an operation at core n+2. Further, since the interpolated corrected result for element #2 is output to core 1, when the corrected result is input to core 1, the operations performed from that time onwards with respect to the common element take the crash of core 3 into consideration. Accordingly, the overall balance of the actuators is adjusted.

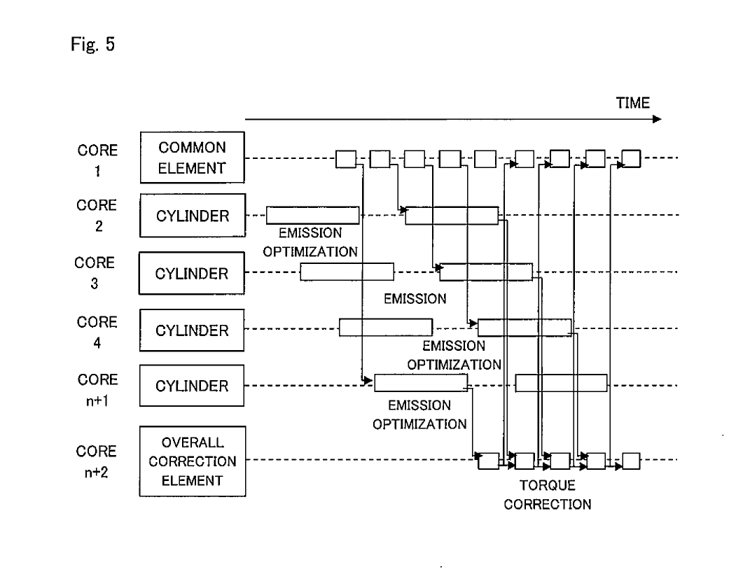

Next, specific examples of the control device of the present embodiment will be described referring to FIG. 5 to FIG. 7. FIG. 5 to FIG. 7 are each diagrams that illustrate a temporal relation between operations performed by respective cores. However, in the respective drawings it is assumed that a plurality of actuators provided for each cylinder of the engine correspond to the plurality of actuators that the above-described control object includes. Note that it is assumed that the number of cylinders is equal to or less than n.

As shown in FIG. 5, when a common element (for example, a basic ignition timing that is common to the first cylinder to nth cylinder) is calculated by an operation at core 1, the operation result is output to core 2 to core n+1. At core 2 to core n+1, an element that is unique to the respective cylinders (for example, a retardation amount of the ignition timing that is necessary to minimize the amount of emission (NOx or the like) discharged from the respective cylinders) is calculated by an operation, and the operation results are output to core n+2. At core n+2, an overall correction element (for example, an advancement amount of the ignition timing necessary to secure the torque required by the engine) is calculated by an operation, and the operation results of core 2 to core n+1 are corrected using the overall correction element. The corrected results obtained at core n+2 are reflected in the operation to calculate the common element.

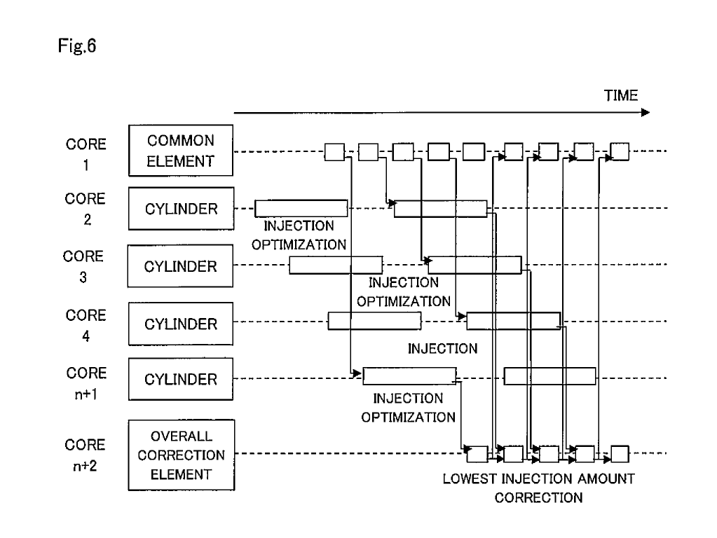

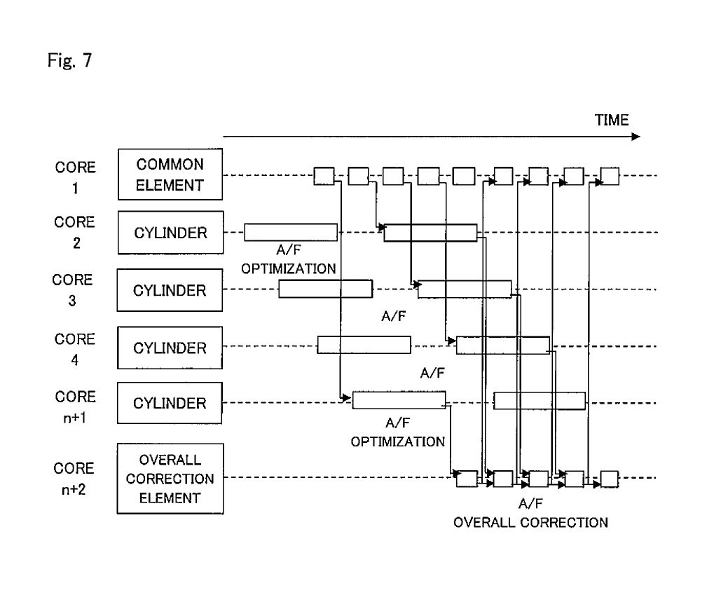

As shown in FIG. 6, when a common element (for example, a target air-fuel ratio that is common to the first cylinder to nth cylinder) is calculated by an operation at core 1, the operation result is output to core 2 to core n+1. At core 2 to core n+1, an element that is unique to the respective cylinders (for example, a fuel injection amount and a fuel injection form necessary to optimize combustion in the respective cylinders) is calculated by an operation, and the operation results are output to core n+2. At core n+2, an overall correction element (for example, a fuel injection amount necessary to secure the torque required by the engine) is calculated by an operation, and the operation results of core 2 to core n+1 are corrected using the overall correction element. The corrected results obtained at core n+2 are reflected in the operation to calculate the common element.

As shown in FIG. 7, when a common element (for example, an intake air amount) is calculated by an operation at core 1, the operation result is output to core 2 to core n+1. At core 2 to core n+1, an element that is unique to the respective cylinders (for example, a fuel injection amount necessary to cause the air-fuel ratio to become a ratio in the vicinity of the stoichiometric ratio in the respective cylinders) is calculated by an operation, and the operation results are output to core n+2. At core n+2, an overall correction element (for example, an amount of increase or decrease in the fuel injection amount that takes into account a deterioration of an exhaust catalyst) is calculated by an operation, and the operation results of core 2 to core n+1 are corrected using the overall correction element. The corrected results obtained at core n+2 are reflected in the operation to calculate the common element.

### REFERENCE SIGNS LIST

100 Control device
102 Core
104 CPU
106 Cache
108 Local memory
110 Bus

1. A control device for controlling a control object comprising a plurality of actuators, wherein:
the control device comprises a multi-core type processor that processes a plurality of operation tasks that are necessary to control operations of the actuators;
the operation tasks include individual tasks that are specific to the respective actuators, and overall tasks that are common to all the actuators;
the processor is configured so as to process the individual tasks and the overall tasks by means of different cores;
the individual tasks are constructed so as to output an operation result in accordance with a demand command with respect to the respective actuators; and
the overall tasks include an operation result correction task that is constructed so as to correct the operation result in accordance with a comprehensive demand command with respect to the actuators.

2. The control device according to claim 1, wherein the overall tasks include a common information creation task that is constructed so as to output information common to the actuators that is information necessary for processing of the individual tasks.

3. The control device according to claim 1, wherein:
the control object is an internal combustion engine; and
the actuators are provided for each of a plurality of cylinders that the internal combustion engine comprises.
